(19) United States
(12) Patent Application Publication
(10) Pub. No.: US 2018/0143435 A1
(43) Pub. Date: May 24, 2018

(54) DISPLAYING DEVICE AND METHOD THEREOF

(71) Applicant: SAMSUNG ELECTRONICS CO., LTD., Suwon-si (KR)

(72) Inventors: Jinho LEE, Suwon-si (KR); Dong Kyung NAM, Yongin-si (KR); Yang Ho CHO, Seongnam-si (KR)

(73) Assignee: SAMSUNG ELECTRONICS CO., LTD., Suwon-si (KR)

(21) Appl. No.: 15/475,915

(22) Filed: Mar. 31, 2017

(30) Foreign Application Priority Data
Nov. 22, 2016 (KR) 10-2016-0156023

(51) Int. Cl. G02B 27/01; G02B 27/22; G02B 26/08

(52) U.S. Cl. CPC G02B 27/0172; G02B 27/2235; G02B 27/225; G02B 26/0833; G02B 2027/0187; G02B 2027/0114; G02B 2027/0134; G02B 2027/0118; G02B 27/0179

(57) ABSTRACT

A displaying device and a displaying method are provided. The displaying device may include a light source configured to emit a plurality of input rays, a spatial light modulator configured to adjust at least one from among a brightness and a color of each of the input rays, and a tilting mirror array configured to adjust a progress direction of each of the input rays of which at least one from among the brightness and the color is adjusted and to output the input rays based on the adjusted progress direction.

### CROSS-REFERENCE TO RELATED APPLICATION

This application claims priority from Korean Patent Application No. 10-2016-0156023, filed on Nov. 22, 2016 in the Korean Intellectual Property Office, the disclosure of which is incorporated herein by reference in its entirety.

### BACKGROUND

### 1. Field

Methods and apparatuses consistent with example embodiments relate to a displaying device and a displaying method.

### 2. Description of the Related Art

Recently, with an increase of three-dimensional (3D) content, a glasses-type 3D television (TV) has been widely provided and a glassless-type 3D TV is being developed. The glasses-type 3D TV provides a 3D image by using polarizing glasses, which may be inconvenient to wear and may cause eye fatigue when used to view 3D images due to an accommodation-vergence conflict.

The glassless-type 3D TV uses a viewpoint-based imaging method of providing a 3D image by implementing a multi-view image using a lenticular lens and a light field-based imaging method of providing a 3D image by recombining two-dimensional (2D) images generated based on a method of combining light field rays.

A system for the viewpoint-based imaging method may cause a decrease in a resolution of a display due to a number of generated viewpoints, and may have limitations with respect to a viewing angle and a viewing distance.

A system for the light field-based imaging method may increase a number of projectors in response to light direction components, thereby securing a desired resolution and realizing a high-resolution 3D image.

### SUMMARY

Example embodiments may address at least the above problems and/or disadvantages and other disadvantages not described above. Also, the example embodiments are not required to overcome the disadvantages described above, and an example embodiment may not overcome any of the problems described above.

According to an aspect of an example embodiment, there is provided a displaying device including a light source configured to emit a plurality of input rays, a spatial light modulator (SLM) configured to adjust at least one from among a brightness and a color of each of the input rays, and a tilting mirror array configured to adjust a propagation direction of each of the input rays of which at least one from among the brightness and the color is adjusted and to output the input rays based on the adjusted propagation direction.

The displaying device may further include a beam splitter (BS) configured to change a propagation direction of each of the input rays of which at least one from among the brightness and the color is adjusted, the BS being disposed between the SLM and the tilting mirror array.

The tilting mirror array may be implemented as a micro mirror array or a micro array device and may include at least one tilting mirror.

The SLM may be further configured to adjust the at least one from among the brightness and the color of each of the input rays based on image information.

The SLM may be further configured to adjust the at least one from among the brightness and the color of each of the input rays based on a viewpoint of a user.

The at least one tilting mirror may include a mirror configured to reflect a ray that is incident to the tilting mirror, a supporter configured to support the mirror, and an electrode configured to adjust an angle of the mirror.

The supporter may be connected to one from among a bottom of the mirror and a side of the mirror.

The supporter may be implemented as a spring.

The tilting mirror array may be further configured to adjust a propagation direction of the ray that is incident to the at least one tilting mirror based on a polarity of the electrode.

The tilting mirror array may be further configured to operate based on one from among an on-off method and a scanning method.

According to another aspect of an example embodiment, there is provided a displaying method that includes emitting a plurality of input rays, adjusting at least one from among a brightness and a color of each of the input rays, and adjusting a propagation direction of each of the input rays of which at least one from among the brightness and the color is adjusted by a tilting mirror array and outputting the input rays based on the adjusted propagation direction.

The displaying method may further include changing a propagation direction of each of the input rays of which at least one from among the brightness and the color is adjusted.

The tilting mirror array may be implemented as one from among a micro mirror array and a micro array device and may include at least one tilting mirror.

The adjusting the at least one from among the brightness and the color may include adjusting the at least one from among the brightness and the color of each of the input rays based on image information.

The adjusting the at least one from among the brightness and the color may include adjusting the at least one from among the brightness and the color of each of the input rays based on a viewpoint of a user.

The at least one tilting mirror may include a mirror configured to reflect a ray that is incident to the at least one tilting mirror, a supporter configured to support the mirror, and an electrode configured to adjust an angle of the mirror.

The supporter may be connected to one from among a bottom of the mirror and a side of the mirror.

The supporter may be implemented as a spring.

The adjusting of the propagation direction may include adjusting a propagation direction of the ray that is incident to the at least one tilting mirror based on a polarity of the electrode.

The tilting mirror array may be configured operate based on one from among an on-off method and a scanning method.

### BRIEF DESCRIPTION OF THE DRAWINGS

The above and/or other aspects will be made more apparent by describing certain example embodiments with reference to the accompanying drawings, in which:

FIG. 1 is a block diagram illustrating a displaying device according to an example embodiment;

FIG. 2 illustrates an operation of a displaying device according to an example embodiment;

FIG. 3A illustrates a tilting mirror included in a tilting mirror array according to an example embodiment;

FIG. 3B illustrates a tilting mirror included in a tilting mirror array according to another example embodiment;

FIG. 4 illustrates a tilting mirror array illustrated in FIG. 1 according to an example embodiment;

FIG. 5 illustrates an operation in which a tilting mirror adjusts a propagation direction of each of light field rays, according to an example embodiment;

FIG. 6 illustrates an operation in which a tilting mirror adjusts a propagation direction of each of light field rays, according to another example embodiment;

FIG. 7A illustrates a tilting mirror array operating based on an on-off method, according to an example embodiment;

FIG. 7B illustrates a tilting mirror array operating based on a scanning method, according to an example embodiment;

FIG. 8 illustrates an example of applying a displaying device to a wearable device, according to an example embodiment;

FIG. 9 illustrates an operation in which a displaying device outputs an image based on a viewpoint of a user, according to an example embodiment; and

FIG. 10 is a flowchart illustrating a displaying method, according to an example embodiment.

### DETAILED DESCRIPTION

Example embodiments are described in greater detail below with reference to the accompanying drawings.

In the following description, like drawing reference numerals are used for like elements, even in different drawings. The matters defined in the present disclosure, such as detailed construction and elements, are provided to assist in a comprehensive understanding of the example embodiments. However, it will be apparent to persons having ordinary skill in the art that the example embodiments can be practiced without those specifically defined matters. Also, well-known functions or constructions may not be described in detail because they would obscure the present disclosure with unnecessary detail.

The terminology used herein is for the purpose of describing the example embodiments only and is not intended to be limiting of the present disclosure. As used herein, the singular forms “a,” “an,” and “the” are intended to include the plural forms as well, unless the context clearly indicates otherwise. It will be further understood that the terms “include/comprise” and/or “have,” when used in the present disclosure, specify the presence of stated features, integers, steps, operations, elements, components, or combinations thereof, but do not preclude the presence or addition of one or more other features, integers, steps, operations, elements, components, and/or groups thereof. In addition, the terms such as “unit,” “-er (-or),” and “module” described in the specification refer to an element for performing at least one function or operation, and may be implemented in hardware, software, or the combination of hardware and software.

Terms such as first, second, A, B, (a), (b), and the like may be used herein to describe components. Each of these terminologies is not used to define an essence, order or sequence of a corresponding component but used to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component.

Unless otherwise defined, all terms, including technical and scientific terms, used herein have the same meaning as is commonly understood by one of ordinary skill in the art to which the present disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, example embodiments are described in detail with reference to the accompanying drawings Like reference numerals in the drawings denote like elements, and a known function or configuration will be omitted herein.

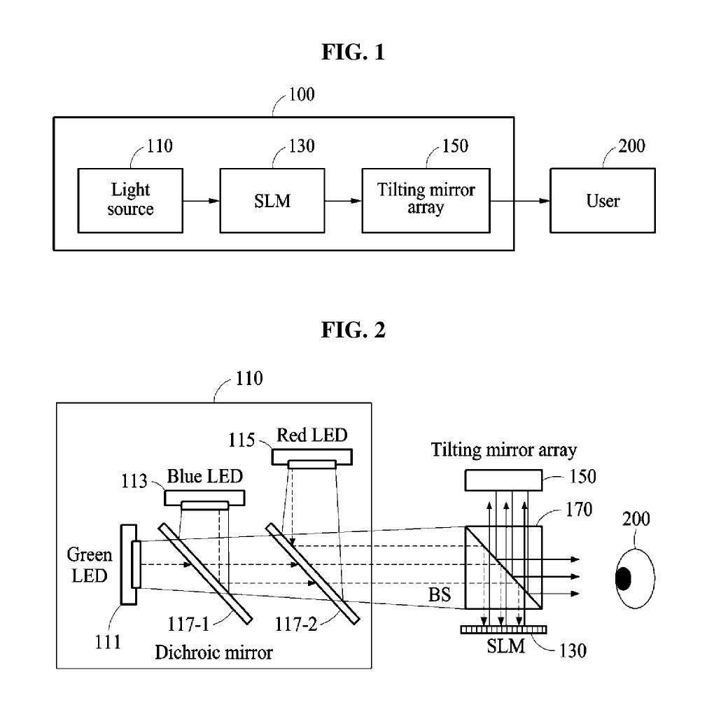

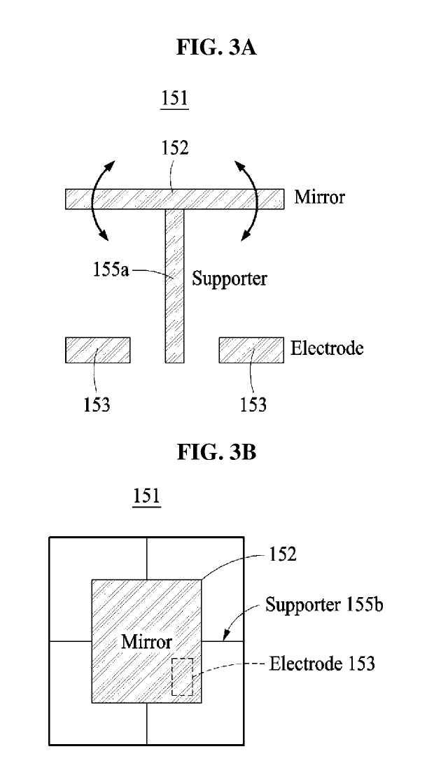

FIG. 1 is a block diagram illustrating a displaying device, according to an example embodiment. FIG. 2 illustrates an operation of a displaying device, according to an exemplary embodiment.

Referring to FIGS. 1 and 2, a displaying device 100 outputs an image and provides the image for a user 200. The image may be a 3D image or an augmented reality (AR) image.

The displaying device 100 may be a light field 3D displaying device. In particular, the displaying device 100 may output light rays of a light field. The light field may be associated with a distribution for each propagation direction or each position of rays reflected from a predetermined object. When the displaying device 100 optically outputs (or reproduces) the light rays of the light field toward a predetermined surface, the user 200 may experience a ray distribution that enables the user 200 to view a natural image of an object and to feel that the object actually exists.

The displaying device 100 includes a light source 110, a spatial light modulator (SLM) 130, and a tilting mirror array 150. The displaying device 100 further includes a beam splitter (BS) 170.

The light source 110 generates and emits a plurality of input rays. For example, the light source 110 may include red, green, and blue (RGB) light sources.

For example, the light source 110 includes a green light source 111, a blue light source 113, a red light source 115, a first dichroic mirror 117-1 and a second dichroic mirror 117-2. The light source 110 may include as a light emitting diode (LED) or a laser. In particular, the green light source 111 may include a green LED or a green laser, the blue light source 113 may include a blue LED or a blue laser, and the red light source 115 may include a red LED or a red laser.

The first dichroic mirror 117-1 and the second dichroic mirror 117-2 allow the input rays to proceed (i.e., propagate) in a particular direction. The first dichroic mirror 117-1 and the second dichroic mirror 117-2 may reflect a ray of a predetermined color and transmit rays of other colors. Hereinafter, a “ray” is also referred to as light.

For example, the first dichroic mirror 117-1 may be configured to reflect a blue ray and the second dichroic mirror 117-2 may be configured to reflect a red ray. As a result, a green ray emitted by the green light source 111 may pass through the first dichroic mirror 117-1 and the second dichroic mirror 117-2. A blue ray emitted by the blue light source 113 may be reflected from the first dichroic mirror 117-1 and pass through the second dichroic mirror 117-2. A red ray emitted by the red light source 115 may be reflected from the second dichroic mirror 117-2 and proceed to the SLM 170. The first dichroic mirror 117-1 and the second dichroic mirror 117-2 may be provided as beam splitters which are similar to one another in properties and operations.

Although FIG. 2 illustrates that input rays emitted by the green light source 111, the blue light source 113, and the red light source 115 are differentiated, the input rays are not limited thereto. The input rays may overlap as a single ray and proceed in one direction.

The SLM 130 adjusts brightness information and/or color information of each of the input rays. For example, the SLM 130 adjusts the brightness information and the color information of the input rays based on image information. The image information may include 2D image information or 3D image information. The SLM 130 may receive the 2D image information or 3D image information.

The SLM 130 may be implemented as a liquid crystal on silicon (LCoS) or a digital micromirror device (DMD).

The tilting mirror array 150 may adjust a progress direction (also referred to herein as a “propagation direction”) of each of a plurality of rays that are received from a pixel of the SLM 130. The rays that are received from the SLM 130 may be light field rays. In particular, the tilting mirror array 150 may adjust a progress direction of each of the light field rays.

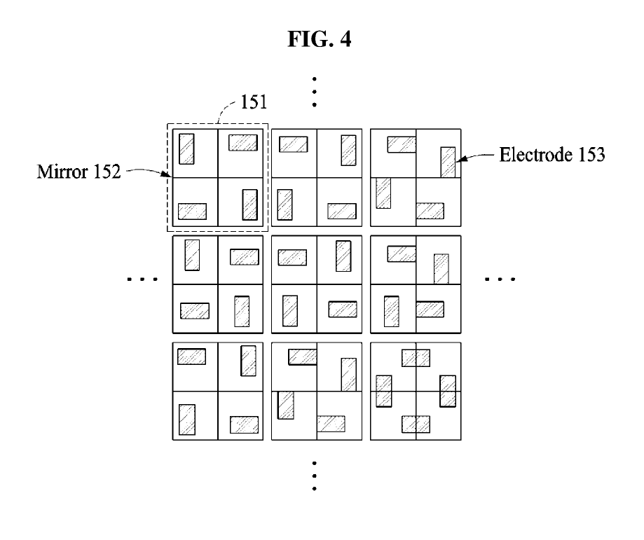

The tilting mirror array 150 includes at least one tilting mirror. For example, the tilting mirror array 150 may be implemented as a micro mirror array or a micro array device that performs substantially the same operation as the micro mirror array. As another example, the tilting mirror array 150 may be implemented as an electro-wetting device. Detailed description of a configuration and an operation of the tilting mirror will be provided below with reference to FIGS. 3A and 3B.

The tilting mirror array 150, that is, at least one tilting mirror, may adjust the propagation direction of each of the light field rays and output the light field rays to the user 200 based on the adjusted propagation direction. Because the light field rays form a uniform light distribution on eyes of the user 200, the user 200 may view a natural image that looks similar to something real.

The tilting mirror array 150 may adjust the propagation direction of each of the light field rays in order to reduce an amount of accommodation-vergence conflict of the 3D display, thereby relieving eye fatigue of the user 200.

The BS 170 changes the propagation direction of each of the light field rays. The BS 170 may reflect a subset of the light field rays and transmit another subset of the light field rays. The BS 170 may be implemented as an X-cube.

The BS 170 changes the propagation direction of each of the light field rays and thus, the displaying device 100 may be a compact device.

The BS 170 may reflect a plurality of incident rays based on a polarization direction or divide a parallel ray. In this aspect, the BS 170 may be implemented as a polarized beam splitter (PBS).

FIG. 3A illustrates a tilting mirror included in a tilting mirror array, according to an example embodiment.

Referring to FIG. 3A, the tilting mirror array 150 includes at least one tilting mirror 151. The tilting mirror 151 includes a mirror 152, at least one electrode 153, and a supporter 155a.

The tilting mirror 151 may be manufactured based on a semiconductor manufacturing process or a micro electro mechanical system (MEMS) manufacturing process. The supporter 155a may be made of silicon (Si). The mirror 152 may be disposed or attached to a top of the supporter 155a. In this aspect, the supporter 155a may be connected to a bottom of the mirror 152 so as to support the mirror 152.

The mirror 152 may change a propagation direction of each of light field rays output from the SLM 130. Here, the mirror 152 may change the propagation direction of each of the light field rays by using the at least one electrode 153 and an electrostatic actuation.

For example, the electrode 153 may adjust a direction (or gradient) of the mirror 152 by applying an attraction force or a repulsion force to the mirror 152. For example, in response to a positive (+) electric potential being applied to the mirror 152 and the positive (+) electric potential being applied to the electrode 153, the mirror 152 may be tilted in an opposite direction (i.e., tilted at an opposing angle) with respect to an angle of the electrode 153. In response to the positive (+) electric potential being applied to the mirror 152 and a negative (−) electric potential being applied to the electrode 153, the mirror 152 may be tilted in a same direction (i.e., tilted at a same angle) with respect to an angle of the electrode 153. In response to the negative (−) electric potential being applied to the mirror 152 and the positive (+) electric potential being applied to the electrode 153, a same principle is applied such that the direction (or gradient or angle) of the mirror 152 may be adjusted. Also, different electric potentials may be applied to each electrode 153 such that the direction (or gradient or angle) of the mirror 152 may be adjusted.

For ease of description, FIG. 3A illustrates a case in which the tilting mirror 151 includes two electrodes that include the electrode 153, but the tilting mirror 151 is not limited to include two electrodes. The tilting mirror 151 may include at least one electrode.

The tilting mirror 151 may variably adjust the progress direction of each of the light field rays that incident on the tilting mirror 151 based on a number of electrodes. For example, in response to the tilting mirror 151 including two electrodes, the tilting mirror 151 controls the light field rays incident on the tilting mirror 151 in two directions. In response to the tilting mirror 151 including four electrodes, the tilting mirror 151 controls the light field rays incident on the tilting mirror 151 in four directions.

FIG. 3B illustrates a tilting mirror included in a tilting mirror array, according to another example embodiment.

Referring to FIG. 3B, the tilting mirror 151 includes the mirror 152, the electrode 153, and a supporter 155b.

The tilting mirror 151 may be manufactured based on a semiconductor manufacturing process or a micro electro mechanical system (MEMS) manufacturing process. The supporter 155b may be made of silicon (Si). The mirror 152 may be disposed or attached to a side of the supporter 155b. In this aspect, the supporter 155b may be connected to a side of the mirror 152 so as to support the mirror 152.

The supporter 155b may be implemented as a spring. The supporter 155b may include a spring in one of various forms, for example, a serpentine type spring and a sigmoid type spring. In this aspect, the supporter 155b may enable the mirror 152 to precisely (or sensitively) reflect the light field rays.

The electrode 153 may adjust a direction (or gradient or angle) of the mirror 152 by applying an attraction force or a repulsion force to the mirror 152. For ease of description, FIG. 3B illustrates a configuration in which a gradient of the mirror 152 is adjusted by using the single electrode 153, but the tilting mirror 151 is not limited thereto. The tilting mirror 151 may adjust the gradient of the mirror 152 by using at least one electrode 153.

Although FIGS. 3A and 3B each illustrate an operation of the tilting mirror 151 to adjust the progress direction (or gradient) of each of the light field rays by using the attraction force and/or the repulsion force, that is, an electrostatic actuation principle, the tilting mirror 151 is not limited thereto. The tilting mirror 151 may adjust the progress direction (or gradient) of each of the light field rays by using an electromagnetic actuation principle or a piezoelectric actuation principle.

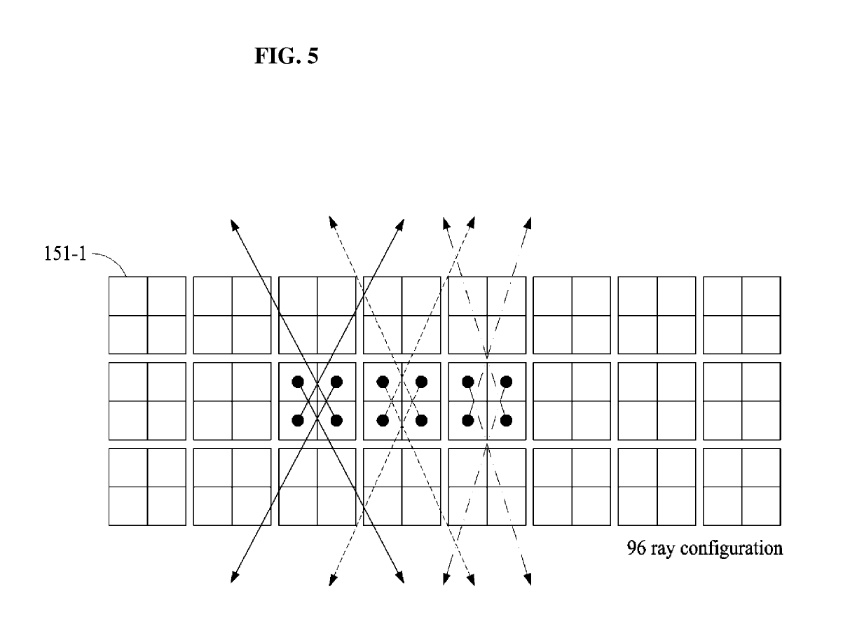

FIG. 4 illustrates the tilting mirror array illustrated in FIG. 1, according to an example embodiment.

Referring to FIG. 4, similarly as a structure of the tilting mirror 151 illustrated in FIG. 3A, at least one tilting mirror included in the tilting mirror array 150 includes the mirror 152, the supporter 155a, and four electrodes including the electrode 153.

The tilting mirror array 150 includes at least one tilting mirror 152, and each tilting mirror 152 may include the mirror 152 and four electrodes including the electrode 153. The electrode 153 may be disposed at a bottom of the mirror 152.

The mirror 152 may variably adjust a progress direction of each of light field rays incident on the mirror 152 based on a number of electrodes that include the electrode 153. The mirror 152 may control the light field rays incident on the mirror 152 in four directions.

Four pixels of the SLM 130 may correspond to the single mirror 152. Here, the mirror 152 may control the light field rays output from four pixels of the SLM 130 in four directions. In response to an operation of the mirror 152, the SLM 130 may be synchronized with the operation of the mirror 152 in four pixel units such that the SLM 130 performs time-division modulation.

In addition, the mirror 152 may variably adjust a progress direction of a ray incident on the mirror 152 based on a position of the electrode 153. In this aspect, when the electrode 153 is variably disposed for each mirror including the mirror 152, a rotation direction of each mirror including the mirror 152 is correspondingly adjusted. Thus, the mirror 152 may variably adjust a progress direction of each of the light field rays that is incident to the mirror 152, and the displaying device 100 may output uniform light field rays.

Although FIG. 4 illustrates that the tilting mirror 151 of the tilting mirror array 150 has a structure of the tilting mirror 151 illustrated in FIG. 3A, the tilting mirror 151 is not limited thereto. The tilting mirror 151 illustrated in FIG. 4 may have a structure of the tilting mirror 151 illustrated in FIG. 3B. In particular, the tilting mirror 151 of FIG. 4 may include the mirror 152, the electrode 153, and the supporter 155b. Here, a position of the supporter 155b may correspond to a position of the electrode 153. The position of the supporter 155b may vary based on positions of different electrodes which include the electrode 153 of the tilting mirror 151.

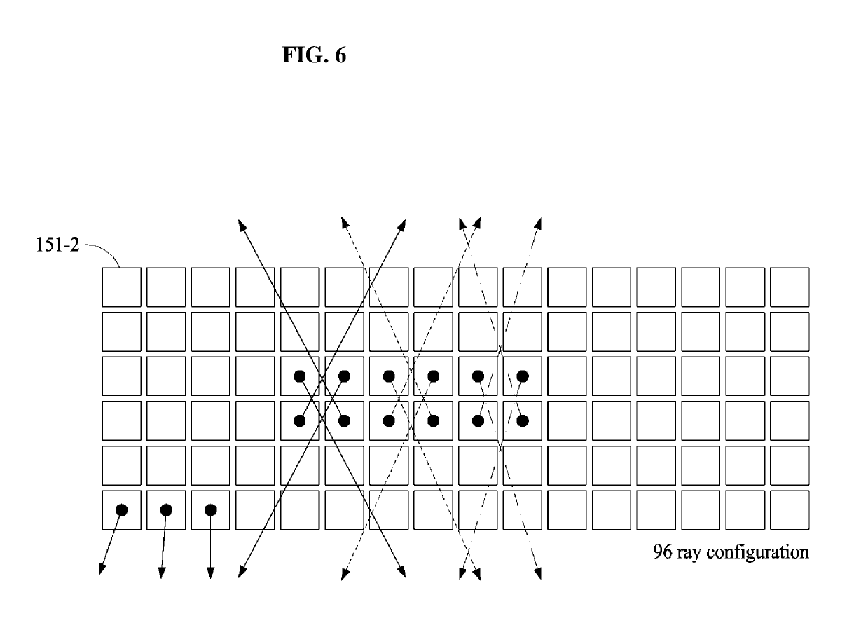

FIG. 5 illustrates an operation in which a tilting mirror adjusts a progress direction of each of light field rays, according to an example embodiment.

Referring to FIG. 5, the tilting mirror array 150 may operate by using 24 tilting mirrors, including a tilting mirror 151-1, as a single unit block. Descriptions provided with reference to FIGS. 3A and 3B may also apply to a configuration of the tilting mirror 151-1.

The tilting mirror 151-1 includes four electrodes, including the electrode 153, at a bottom of the tilting mirror 151-1, and controls rays output from the SLM 130 in four directions. Here, the tilting mirror array 150 may control light field rays output from the SLM 130 in an identical direction or in different directions based on a design of spatial distribution of the light field rays.

In response to the tilting mirror array 150 adjusting a progress direction of each of 96 light field rays that are propagating in different directions, the tilting mirror array 150 may include a plurality of blocks that has 24 tilting mirrors including the tilting mirror 151-1 illustrated in FIG. 5 as a single unit block.

Four pixels of the SLM 130 may correspond to the tilting mirror 151-1. Here, the tilting mirror 151-1 may control light field rays output from the four pixels of the SLM 130 in four respective directions. In response to an operation of the tilting mirror 151-1, the SLM 130 may be synchronized with the operation of the tilting mirror 151-1 in four pixel units such that SLM 130 performs time-division modulation.

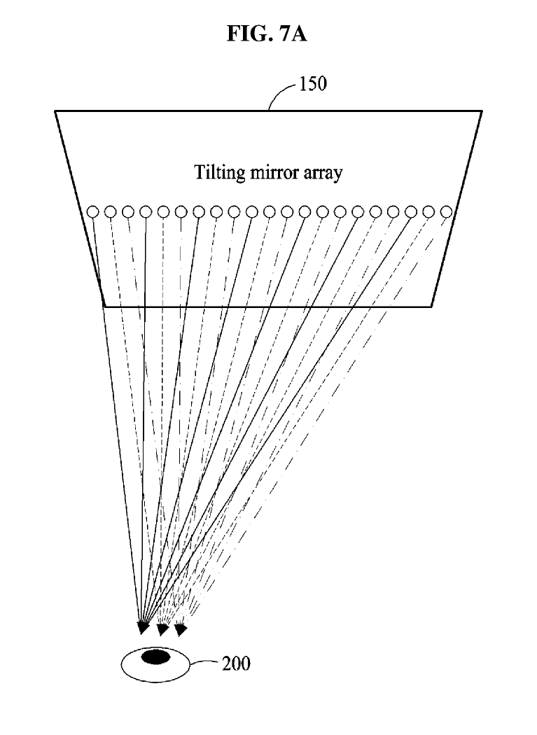

FIG. 6 illustrates an operation in which a tilting mirror adjusts a progress direction of each of light field rays, according to another example embodiment.

Referring to FIG. 6, the tilting mirror array 150 includes 96 tilting mirrors, including a tilting mirror 151-2. Descriptions provided with reference to FIGS. 3A and 3B may also apply to a configuration of the tilting mirror 151-2.

The tilting mirror 151-2 includes at least the single electrode 153 at a bottom of the tilting mirror 151-2 and adjusts a progress direction of each of light field rays output from the SLM 130. Here, the tilting mirror array 150 may control light field rays output from the SLM 130 in an identical direction or in different directions based on a design of spatial distribution of the light field rays.

In response to the tilting mirror 150 adjusting a progress direction of each of 96 light field rays that are propagating in different directions, the tilting mirror array 150 may include a plurality of blocks that has 96 tilting mirrors including the tilting mirror 151-2 illustrated in FIG. 6 as a single unit block.

A single pixel of the SLM 130 may correspond to the tilting mirror 151-2. Here, the tilting mirror 151-2 may control light field rays output from the single pixel in one direction. In response to an operation of the tilting mirror 151-2, the SLM 130 may be synchronized with the operation of the tilting mirror 151-2 in a single pixel unit such that SLM 130 performs time-division modulation.

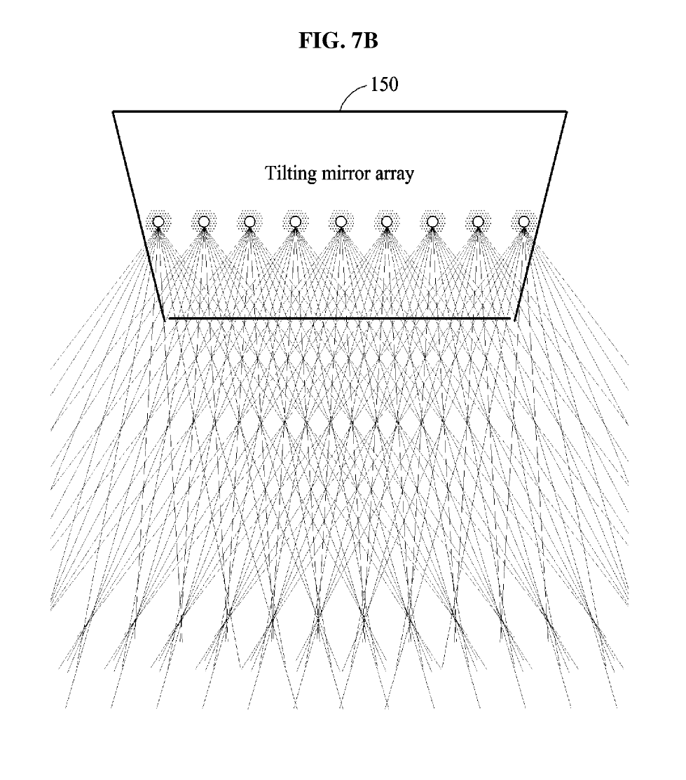

FIG. 7A illustrates a tilting mirror array operating based on an on-off method, according to an example embodiment.

Referring to FIG. 7A, the tilting mirror array 150 operates based on the on-off method. For example, in response to the tilting mirror array 150 being in an on state, light field rays reflected from a tilting mirror propagate in one direction. For example, the light field rays propagate toward eyes of the user 200.

FIG. 7B illustrates a tilting mirror array operating based on a scanning method, according to an example embodiment.

Referring to FIG. 7B, the tilting mirror array 150 operates based on the scanning method. For example, each of a plurality of tilting mirrors of the tilting mirror array 150 rotates (or scans) light field rays in a state in which predetermined angles between the light field rays are maintained. Thus, a total number of the light field rays increases such that the displaying device 100 may output (or realize) a more natural image.

When the tilting mirror array 150 operates based on the scanning method or a step method, the total number of the light field rays may be adjusted.

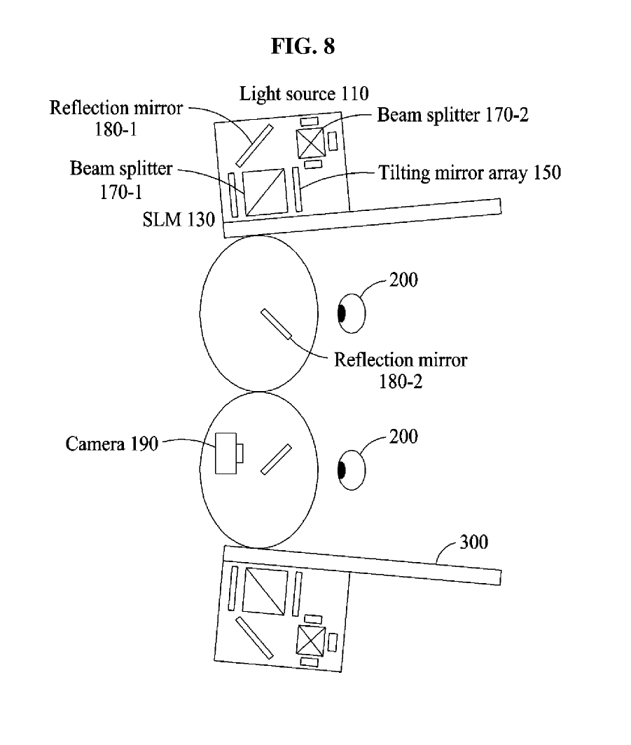

FIG. 8 illustrates an example of applying a displaying device to a wearable device, according to an example embodiment.

Referring to FIG. 8, the displaying device 100 is provided in a wearable device 300. The displaying device 100 may be provided on each of a left side and a right side of the wearable device 300. The displaying device 100 includes the light source 110, the SLM 130, the tilting mirror array 150, a first beam splitter (BS) 170-1, a second BS 170-2, a first reflection mirror 180-1, and a second reflection mirror 180-2. The displaying device 100 further includes a camera 190.

Descriptions of the light source 110, the SLM 130, the tilting mirror array 150, and the BS 170 of FIGS. 1 and 2 may also apply to the light source 110, the SLM 130, the tilting mirror array 150, the first BS 170-1, and the second BS 170-2 of FIG. 8. Thus, duplicated descriptions thereof will be omitted for conciseness.

The first reflection mirror 180-1 and the second reflection mirror 180-2 may adjust a respective propagation direction of each of rays. For example, the first reflection mirror 180-1 enables a plurality of input rays emitted by the light source 110 to propagate toward the first BS 170-1.

The first BS 170-1 may output a plurality of input rays reflected from the first reflection mirror 180-1 to the SLM 130, and enable the propagation of the light field rays output from the SLM 130 to the tilting mirror array 150.

The tilting mirror array 150 may adjust a progress direction of each of the light field rays. The light field rays may be reflected from the first BS 170-1 and the second reflection mirror 180-2 and output to the user 200. In particular, the first BS 170-1 and the second reflection mirror 180-2 may reflect the light field rays and output the light field rays to the user 200.

The camera 190 may track a viewpoint of the user 200. The camera 190 may be a viewpoint tracking camera. The displaying device 100 may output an image based on the viewpoint of the user 200.

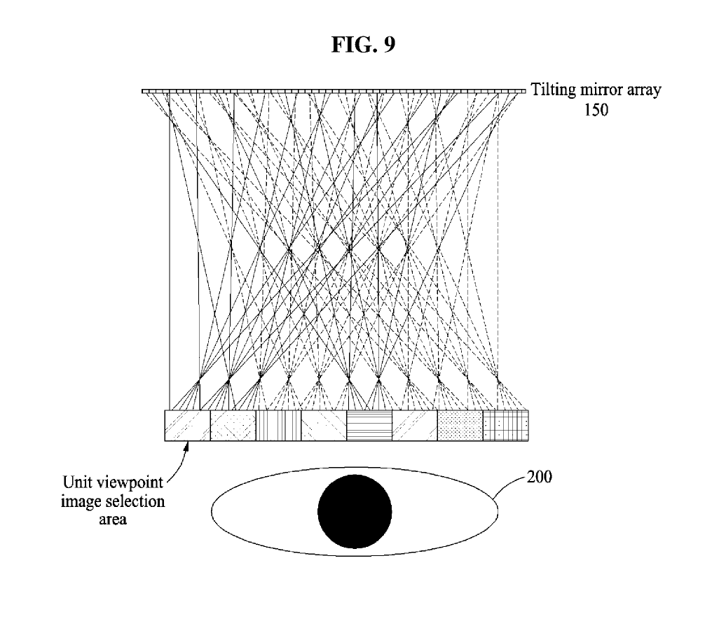

FIG. 9 illustrates an operation in which a displaying device outputs an image based on a viewpoint of a user, according to an example embodiment.

Referring to FIG. 9, image information received by the first BS 170-1 may be generated based on a propagation direction of each of light field rays depending on a viewpoint, for example, a position of a pupil, of the user 200. The image information may be associated with an image based on an augmented reality (AR) viewpoint.

The light field rays output from the first BS 170-1 may reach the pupil of the user 200 propagating in a horizontal direction with respect to the pupil. The light field rays may be divided at predetermined intervals based on the horizontal direction. The displaying device 100 may select the image information based on light field rays included in divided areas and input (or map) the image information to a pixel that corresponds to a viewing direction of the user 200. Based on a same principle, when the image information based on the viewpoint of the user 200 is input (or mapped) to every pixel, the displaying device 100 may output a natural image that looks similar to something real.

The displaying device 100 may generate a mapping table based on the image information on the viewpoint of the user 200 and adjust the progress direction of each of the light field rays.

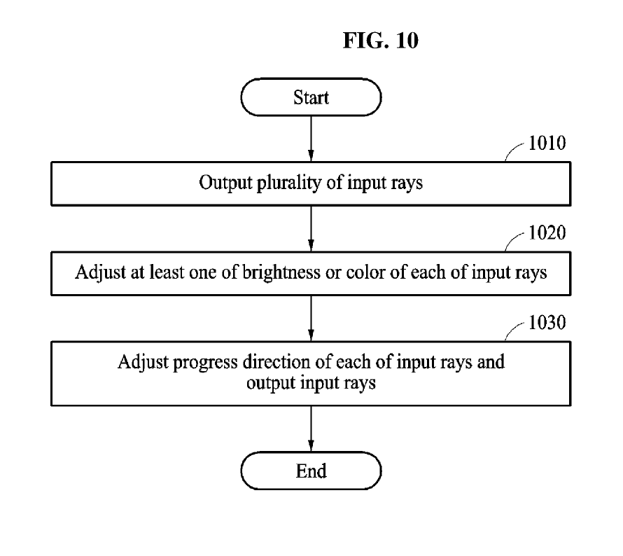

FIG. 10 is a flowchart illustrating a displaying method, according to an example embodiment.

Referring to FIG. 10, in operation 1010, a displaying method includes an operation of outputting a plurality of input rays. The input rays may be emitted by the light source 110. The light source 110 may be a light emitting diode (LED) or a laser. The light source 110 may be a light source that emits at least one from among a red ray, a green ray, and a blue ray.

In operation 1020, the displaying method includes an operation of adjusting at least one from among a brightness and a color of each of the input rays. The operation of the adjusting includes an operation of adjusting at least one from among the brightness and the color of each of the input rays based on image information. The image information may include one from among a two-dimensional (2D) image and a three-dimensional (3D) image. The image information may include image information generated based on a viewpoint of a user.

In operation 1030, the displaying method includes an operation of adjusting a progress direction of each of the input rays of which at least one from among the brightness and the color is adjusted by the tilting mirror array 150 and outputting the input rays, based on the adjusted progress direction.

The tilting mirror array 150 includes at least one tilting mirror 151. The tilting mirror 151 includes the mirror 152 configured to reflect rays that are incident to the tilting mirror 151, the supporters 155a and 155b configured to support mirrors, and the electrode 153 configured to adjust a direction (i.e., an angle) of the mirror 152.

The rays input to the tilting mirror 152 may be light field rays. The tilting mirror array 150 may form uniform light field rays by adjusting the progress direction of each of the light field rays.

The above-described example embodiments may be recorded in non-transitory computer-readable media that include program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as compact disc-read-only memory (CD-ROM) discs and digital versatile discs (DVDs); magneto-optical media such as optical discs; and hardware devices that are specially configured to store and perform program instructions, such as read-only memory (ROM), random access memory (RAM), flash memory, and the like. The media may include transfer media such as optical lines, metal lines, or waveguides that include a carrier wave for transmitting a signal designating the program command and the data construction. Examples of program instructions include both machine code, such as code produced by a compiler, and files containing higher level code that may be executed by the computer by using an interpreter. The described hardware devices may be configured to act as one or more software modules in order to perform the operations of the above-described example embodiments, or vice versa.

The foregoing example embodiments are examples and are not to be construed as limiting. The present disclosure can be readily applied to other types of apparatuses. Also, the description of the example embodiments is intended to be illustrative, and not to limit the scope of the claims, and many alternatives, modifications, and variations will be apparent to persons having ordinary skill in the art.

What is claimed is:

1. A displaying device comprising:
a light source configured to emit a plurality of input rays;
a spatial light modulator configured to adjust at least one from among a brightness and a color of each of the input rays; and
a tilting mirror array configured to adjust a propagation direction of each of the input rays of which at least one from among the brightness and the color is adjusted, and to output the input rays based on the adjusted propagation direction.

2. The displaying device of claim 1, further comprising a beam splitter configured to change a propagation direction of each of the input rays of which at least one from among the brightness and the color is adjusted, wherein the beam splitter is disposed between the spatial light modulator and the tilting mirror array.

3. The displaying device of claim 1, wherein the tilting mirror array is a micro mirror array or as a micro array device, and comprises at least one tilting mirror.

4. The displaying device of claim 1, wherein the spatial light modulator is further configured to adjust the at least one from among the brightness and the color of each of the input rays based on image information.

5. The displaying device of claim 1, wherein the spatial light modulator is further configured to adjust the at least one from among the brightness and the color of each of the input rays based on a viewpoint of a user.

6. The displaying device of claim 3, wherein the at least one tilting mirror comprises:
a mirror configured to reflect a ray that is incident to the at least one tilting mirror;
a supporter configured to support the mirror; and
an electrode configured to adjust an angle of the mirror.

7. The displaying device of claim 6, wherein the supporter is connected to one from among a bottom of the mirror and a side of the mirror.

8. The displaying device of claim 7, wherein the supporter comprises a spring.

9. The displaying device of claim 6, wherein the tilting mirror array is further configured to adjust a propagation direction of the ray that is incident to the at least one tilting mirror based on a polarity of the electrode.

10. The displaying device of claim 1, wherein the tilting mirror array is further configured to operate based on one from among an on-off method and a scanning method.

11. A displaying method comprising:
emitting a plurality of input rays;
adjusting at least one from among a brightness and a color of each of the input rays; and
adjusting a propagation direction of each of the input rays of which at least one from among the brightness and the color is adjusted by using a tilting mirror array, and outputting the input rays based on the adjusted propagation direction.

12. The method of claim 11, further comprising:
changing a propagation direction of each of the input rays of which at least one from among the brightness and the color is adjusted.

13. The method of claim 11, wherein the tilting mirror array is one from among a micro mirror array and a micro array device, and comprises at least one tilting mirror.

14. The method of claim 11, wherein the adjusting the at least one from among the brightness and the color comprises adjusting the at least one from among the brightness and the color of each of the input rays based on image information.

15. The method of claim 11, wherein the adjusting the at least one from among the brightness and the color comprises adjusting the at least one from among the brightness and the color of each of the input rays based on a viewpoint of a user.

16. The method of claim 13, wherein the at least one tilting mirror comprises:
a mirror configured to reflect a ray that is incident to the at least one tilting mirror;
a supporter configured to support the mirror; and
an electrode configured to adjust an angle of the mirror.

17. The method of claim 16, wherein the supporter is connected to one from among a bottom of the mirror and a side of the mirror.

18. The method of claim 17, wherein the supporter comprises a spring.

19. The method of claim 16, wherein the adjusting the propagation direction comprises adjusting a propagation direction of the ray that is incident to the at least one tilting mirror based on a polarity of the electrode.

20. The method of claim 11, wherein the tilting mirror array is configured to operate based on one from among an on-off method and a scanning method.
